(19) United States
(12) Patent Application Publication
(10) Pub. No.: US 2013/0241725 A1
(43) Pub. Date: Sep. 19, 2013

(54) Roadway Medical Complication Alert Method and Device

(71) Applicant: Ruben Cancio, Miami, FL (US)

(72) Inventor: Ruben Cancio, Miami, FL (US)

(21) Appl. No.: 13/420,642

(22) Filed: Mar. 15, 2012

(51) Int. Cl. B60Q 7/00

(52) U.S. Cl. 340/473

(57) ABSTRACT

A roadway medical complication alert method for provides a remotely monitored roadway medical complication alert device on a vehicle to a patient with at least one medical complication who is hurriedly proceeding on a roadway to a health care professional. The roadway medical complication alert method allows a woman who experiences excessive pregnancy complications and contractions to obtain a special limited time medical prescription from a health care professional, such as gynecologist. The medical prescription permits the women access to obtain and register, from a roadway authority, a roadway medical complication alert device. The roadway medical complication alert device also utilizes technological components for remotely monitoring the vehicle, including a beacon for transmitting the vehicle position to a monitored remote user interface. If the woman is belated in returning the roadway medical complication alert device after the limited time prescription or medical complication terminates, she is penalized.

### BACKGROUND

The present invention is directed to a roadway medical complication alert method and device. The roadway medical complication alert method provides a remotely monitored roadway medical complication alert device on a vehicle to a patient with at least one medical complication who is hurriedly proceeding on a roadway to a health care professional.

The inventor of the present invention is a father. When his wife was pregnant he noticed how much time it consumed to take her back and forth from their home to the hospital due to traffic congestion, traffic lights, and stop signs. One day his wife was experiencing contractions. As they were rushing to the hospital they were pulled over by a state trooper. The trooper did not notice that the wife was experiencing contractions until he walked up to the car and heard the wife screaming from pain. After realizing the situation, the trooper let the couple go without question. At this moment the inventor of the current invention recognized a problem.

The inventor thought about his predicament, and envisioned creating a warning system similar to the one used by emergency vehicles; except for pregnant woman. The system would be able to alleviate the stresses and hazards associated with transporting the pregnant woman to the hospital. Furthermore, the system could reduce travel time by informing fellow drivers and pedestrians on the roadway of the medical emergency. This would reduce the time wasted by traffic congestion, traffic lights, and stop signs, and eliminate these obstacles. This system would also have the capability of informing the law enforcement officers on the roadway that there was a medical emergency. The officers would have the choice of escorting the vehicle containing the pregnant woman to the hospital or, at least not stopping the vehicle.

After the husband got home from the hospital he started researching the amount of time and energy that is lost when a woman is being rushed to the hospital. He found that there were many instances of women's water breaking while being puled over by law enforcement, leading to wasted time of that officer that could be spent more wisely. On top of that there were instances of a pregnant woman driving in traffic and her water breaks and slows traffic while the ambulance arrives to take her to the hospital. He realized that it all boiled down to the time saved by informing people that there was a pregnant woman rushing to the hospital and they should exercise caution.

As the inventor was brainstorming of how to implement his idea, he settled on a system of disbursing a medical prescription alert device as if it were a medication. An issue brought to his attention was that when women experienced contractions, they often drove to hospitals and that they required an easy method of being able to warn others of their predicament. The present invention is a method that uses a light that can only be used by women in distress when going to see a physician; the light can be tracked remotely when being placed in use.

The inventor also noticed that there was potential for abuse of the warning device, such as people using the warning device to run their errands more efficiently. He decided to incorporate a registration system and penalty structure for belated returns of the warning device. He also utilized a beacon in the device to monitor the device's position on the roadways. The monitoring system has the capability of communicating the location of said alert device. This information can be sent to officers or emergency personnel in the case when the car breaks down or if the alert device stops communicating before it reaches the hospital. This information can be used to prove the misuse of the alert device and fines issued accordingly.

For the foregoing reasons, there is a Roadway Medical Complication Alert Method and Device that is prescribed like medication to qualified pregnant women; affixes to the vehicle of a pregnant woman who is hurrying to the hospital; alerts law enforcement, drivers, and pedestrians on the roadway of the hurriedly proceeding vehicle; monitors the location and usage of the alert device; and prevents abuse by requiring registration and penalizing belated returns of the device.

Warning devices for the roadways have been utilized in the past; yet none with the present cost reducing characteristics of the present invention. See U.S. Patent No. 2010/0019932; 2004/0021580; and U.S. Pat. No. 4,552,089.

For the foregoing reasons, there is a roadway medical complications alert method and device that allows a pregnant woman to more safely and efficiently arrive at the hospital during medical complications or labor.

### SUMMARY

The present invention is directed to a roadway medical complication alert method and device that can be remotely monitored that will place others on notice that the person using the device is in distress. The device shall only be issued to pregnant women that have pregnancy related complications or women that are at least in their second trimester of pregnancy. The roadway medical complication alert method allows a woman who experiences excessive pregnancy complications and contractions to obtain a special limited time medical prescription from a health care professional, such as gynecologist. Upon reaching six months into the pregnancy, the woman qualifies to obtain the limited time prescription. The medical prescription permits the women access to obtain and register, from a roadway authority, a roadway medical complication alert device.

The roadway medical complication alert device is a portable warning light with a magnetic base that actuates upon engaging with a metal surface of the vehicle. The roadway medical complication alert device includes numerous components that allow it to efficaciously alert drivers and pedestrians on a roadway that the woman using the alert device is hurriedly proceeding to the hospital or to see her physician. The chief components of the device include: a base, wherein the roadway medical complication alert device actuates when the base engages the vehicle; at least one lens member; at least one illuminating member; a power source; a control circuit operatively connected to the at least one illuminating member to produce at least one visually distinct alerting light signal; and a beacon device for transmitting a vehicle position to a remote processor. The roadway medical complication alert device also utilized exterior technological components that allow for remotely monitoring the vehicle while the woman proceeds to the hospital during labor. These include: a remote user interface for monitoring the vehicle position through the beacon device, the remote user interface being in communication with the remote processor.

In function, the roadway medical complication alert device is a flashing light positioned on the top of the vehicle that alerts fellow drivers and pedestrians that the vehicle has a pregnant woman inside who is hurriedly preceding to the hospital. The roadway medical complication alert device includes a beacon that relays its position to a remote processor. A remote user interface that communicates with the remote processor monitors a position of the vehicle, and reports the position to the roadway authorities, such as law enforcement officers. In one embodiment, police might escort the vehicle to the hospital. After the woman terminates her pregnancy or the limited time prescription terminates, the woman is obligated to return the roadway medical complication alert device to the roadway authorities. If the woman is belated in returning the roadway medical complication alert device, she is penalized. In one embodiment, the penalty could be a $250 fine and could include further late penalty fees.

An object of the present invention is to allow a woman with the pregnancy related medical complication to have safe and efficient access to the hospital and the health care professional during labor; whether the woman drives herself, or is driven.

Another object of the present invention is to alert other drivers and pedestrians that the vehicle is hurriedly proceeding to the hospital, for it is carrying a pregnant woman in distress.

Another object of the present invention is to regulate the number of pregnant women obtaining the roadway medical complication alert device by requiring the limited time prescription and registration with the roadway authorities.

Another object of the present invention is to help law enforcement officials identify the vehicle rushing to the hospital so that they can escort the vehicle to the hospital and avoid stopping the vehicle.

### DRAWINGS

These and other features, aspects, and advantages of the present invention will become better understood with regard to the following description, appended claims, and drawings where:

FIG. 1 is a flowchart showing the steps in the roadway medical complication alert method;

FIG. 2 is a block diagram showing the chief components of the roadway medical complication alert method; and

FIG. 3 is a sectioned side view of the roadway medical complication alert device.

### DESCRIPTION

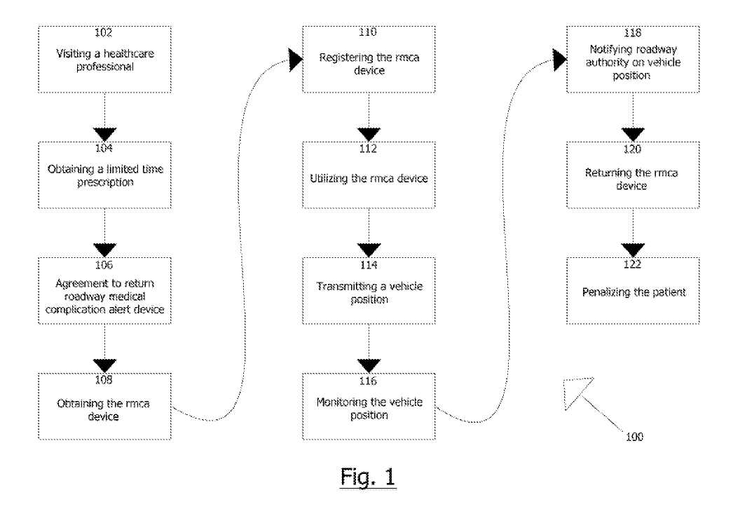

One embodiment of a roadway medical complication alert method 100 is illustrated in FIGS. 1-3. The roadway medical complication alert method 100 is used to provide a remotely monitored roadway medical complication alert device 200 on a vehicle 300 to a patient 302 with at least one medical complication 306 who is hurriedly proceeding on a roadway 314 to see a health care professional 304. The roadway medical complication alert method 100 comprises the following steps:

Visiting 102 a health care professional 304 with regards to at least one medical complication 306. If the health care professional 304 diagnosis that the patient 302 has the at least one medical complication 306 that justifies a need for the roadway medical complication alert method 100, the next step is, obtaining 104 a limited time prescription 308. Prior to obtaining the roadway medical comp cation alert device 200 though, the patient 302 commits to agreeing 106 to return the roadway medical complication alert device 200 after the at least one medical complication 306 or the limited time prescription 308 terminate. The patient 302 then is free to proceed to a roadway authority 310 for the purpose of obtaining 108 the roadway medical complication alert device 200. Next, the patient 302 registers 110 the roadway medical complication alert device 200 with the roadway authority 310. The patient 302 is then able to perform the step of utilizing 112 the roadway medical complication alert device 200 on the vehicle 300 while proceeding to the health care professional 304 during the at least one medical complication 306. While proceeding to the health care professional 304, the vehicle 300 is transmitting 114 a vehicle position 312 from the roadway medical complication alert device 200 to a remote processor 218. Monitoring 116 the vehicle position 312 from a remote user interface 220 is then possible; with the remote processor 218 functioning to communicate the vehicle position 312 to the remote user interface 220. Because the vehicle 300 is monitored, notifying 118 at least one roadway authority 310 on the vehicle position 312 as the patient 302 proceeds to the health care professional 304 is possible. The patient 302 is then responsible for returning 120 the roadway medical complication alert device 200 to the roadway authority 310 after the at least one medical complication 306 or the limited time prescription 308 terminate. There is also a final step of penalizing 122 the patient 302 for belatedly returning the roadway medical complication alert device 200 after the at least one medical complication 306 or the limited time prescription 308 terminate (See FIG. 1).

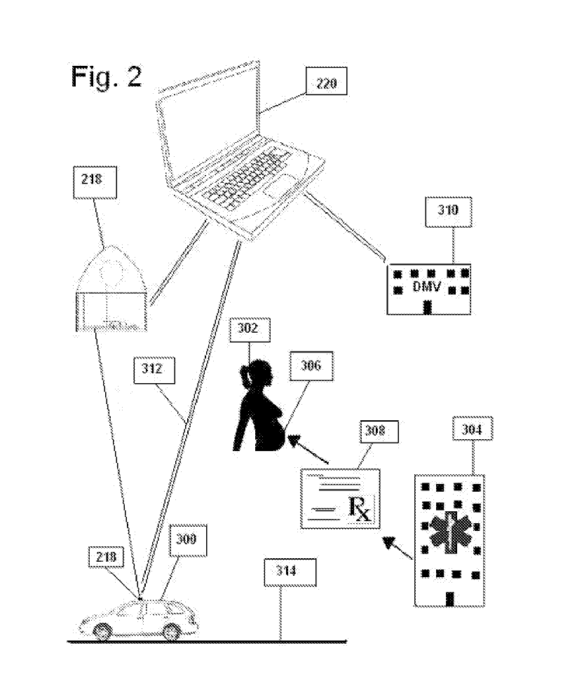

In one embodiment (See FIG. 2), the patient 302 is a pregnant woman and the health care professional 304 is a gynecologist. However there are other embodiments in which the patient 302 could be epileptic, or susceptible to heart disease. Upon reaching six months into the pregnancy, the pregnant woman qualifies to obtain the limited time prescription 308. The limited prescription permits 308 the woman access to obtain and register, from the roadway authority 310, the roadway medical complication alert device 200. The health care professional 304 prescribes the limited time prescription 308. The limited time prescription 308 is only prescribed to the patient 302 with at least one medical complication 306, such as early contractions, leaking water, and the like. This is to avoid abuse and retain the integrity of the roadway medical complication alert method 100. The patient 302 then signs appropriate forms, agreeing to return the roadway medical complication alert device 200 after the at least one medical complication 306 or the limited time prescription 308 terminates. The patient 302 then goes to the Department of Motor Vehicles, or similar governing roadway authority 310 to obtain the roadway medical complication alert device 200. There could be a fee involved. The patient 302 also registers the roadway medical complication alert device 200 so that the roadway authority 310 can better monitor the patient's 302 use of the roadway medical complication alert device 200. The roadway authority 310, for this purpose, is the Department of Motor Vehicles, a law enforcement officer, or a similar bureaucratic department responsible for maintaining maintenance and safety on the roadways.

At the time of labor or other pregnancy related complication, the patient 302 attaches the roadway medical complication alert device 200 to the roof of the vehicle 300 used for transporting the patient 302 to the health care professional 304. Upon engagement with the roof of the vehicle 300, the roadway medical complication alert device 200 actuates to emit a pink light. Simultaneous audio alerts are also possible from the roadway medical complication alert device 200. The intent of the pink light is to signal to the other drivers and pedestrians on the roadway 314 that the vehicle 300 is hurriedly preceding to the health care professional 304—most likely in a hospital or clinic. The roadway medical complication alert device 200 includes a beacon device 216 that transmits the vehicle position 312 to the remote processor 218. The remote user interface 220 then communicates with the remote processor 218 to monitor the vehicle position 312. The vehicle position 312 is used to inform the roadway authorities 310, such as law enforcement officers, that the patient 302 is hurriedly preceding to the hospital. For example, police escort the vehicle 300 to the hospital, or know not to stop the vehicle 300. After the woman terminates her pregnancy or the limited time prescription 308 terminates, the woman is obligated to return the roadway medical complication alert device 200 to the roadway authorities 310. If the woman is belated in returning the roadway medical complication alert device 200, she is penalized. The penalty is a $250 fine and $20 each month thereafter.

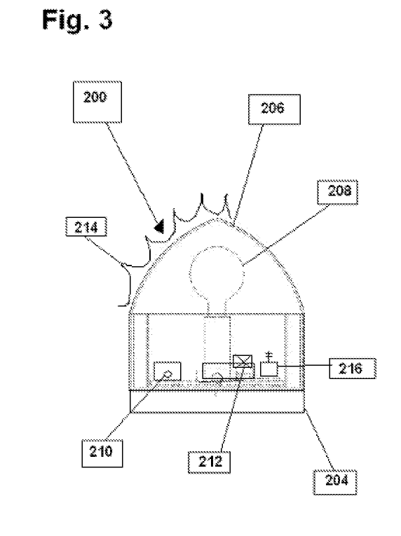

The roadway medical complication alert device 200 that is used in the roadway medical complication alert method 100 comprises of the following components: The roadway medical complication alert device 200 comprises of a base 204 (See FIG. 3). The roadway medical complication alert device 200 further comprises of at least one lens member 206. The roadway medical complication alert device 200 further comprises of at least one illuminating member 208. The roadway medical complication alert device 200 further comprises of a power source 210. The roadway medical complication alert device 200 further comprises of a control circuit 212 operatively connected to the at least one illuminating member 208 to produce at least one visually distinct alerting light signal 214. The roadway medical complication alert device 200 further comprises of a beacon device 216 for transmitting a vehicle position 312. A remote processor 218 is utilized for receiving transmissions of the vehicle position 312 from the beacon device 216. And a remote user interface 220 is utilized for monitoring the vehicle position 312 and notifying the vehicle position 312; wherein the remote user interface 220 communicates with the remote processor 218.

In one embodiment, the roadway medical complication alert device 200 actuates when the base 204 engages the vehicle 300. The base 204 is magnetic and attaches to the metal roof of the vehicle 300. Each lens member 206 is configured to reflect light in multiple directions. Each illuminating member 208 might be a pink light bulb. The color pink is ideal for this purpose because of its association with babies and pregnancies. However other colors could be utilized for different types of medical complications 306. The power source 210 is internally positioned, portable. A lithium battery or any other type of battery now known or later developed may be used. However, in further embodiments, a power cord could attach the roadway medical complication alert device 200 to a vehicle power source, such as a lighter outlet. A control circuit 212 is operatively connected to the at least one illuminating member 208 to produce at least one visually distinct alerting light signal 214. The control circuit 212 utilizes a standard lighting schematic to regulate current throughout the roadway medical complication alert device 200. The visually distinct alerting light signal 214 might be a flashing pink illumination that informs other drivers and pedestrians on the roadway 314 that the vehicle 300 is going to the hospital or clinic.

The beacon device 216 might transmit the vehicle position 312 through a satellite global positioning system to the remote processor 218. The remote processor 218 might be a server or any other cloud technology. However, it is foreseen that any future technological advancements of remote processing might perform the same task. In a further embodiment, a SIM card might alert the remote processor 218 that the roadway medical complication alert device 200 is actuated. The remote processor 218 communicates with the remote user interface 120, such as a private company or the Department of Motor Vehicles, to monitor the vehicle position 312 as the vehicle 300 travels to the health care professional. This would allow, for example, a police officer to the vehicle 300 to a hospital.

An advantage of the present invention is that it allows a pregnant woman to quickly and safely arrive to a hospital during a medical emergency.

Another advantage of the present invention is that it does not require expensive equipment or excessive staffing of the roadway authorities 310.

Yet another advantage of the present invention are numerous abuse prevention techniques such as, the utilization of limited time prescriptions 308, registration requirements, penalization for belated returns, and remote monitoring.

Yet another advantage of the present invention is the potential to generate revenue for a municipality or roadway authority 310 through penalty fees or registration fees.

Thus the reader will see that the roadway medical complication alert method 100 and roadway medical complication alert device 200: protects the health of a pregnant woman who has pregnancy related complications, protects the public from vehicles 300 that are hurriedly proceeding to the hospital, and generates revenue.

While the inventor's above description contains many specificities, these should not be construed as limitations on the scope, but rather as an exemplification of several preferred embodiments thereof. Many other variations are possible. For example, the roadway medical complication alert method 100 could be utilized for patients 302 with epileptic seizures. Accordingly, the scope should be determined not by the embodiments illustrated, but by the appended claims and their legal equivalents.

What is claimed is:

1. A roadway medical complication alert method for providing a roadway medical complication alert device on a vehicle to a patient with at least one medical complication proceeding to a health care professional, the roadway medical complication alert method comprising:
visiting a health care professional about the medical complication;
obtaining a limited time prescription for the roadway medical complication alert device from the health care professional;
agreeing to return the roadway medical complication alert device after the medical complication terminates;
obtaining the roadway medical complication alert device from a roadway authority;
registering the roadway medical complication alert device with the roadway authority;
utilizing the roadway medical complication alert device on the vehicle while proceeding to the health care professional during the medical complication;
transmitting a vehicle position from the roadway medical complication alert device to a remote processor;
monitoring the vehicle position from a remote user interface, the remote user interface communicating with the remote processor;
notifying the roadway authority of the vehicle position while the patient proceeds to the health care professional;
returning the roadway medical complication alert device to the roadway authority after the medical complication terminates; and
if the medical complication alert device is not returned after the medical complication terminates, then penalizing the patient for belatedly returning the roadway medical complication alert device.

2. The roadway medical complication alert method of claim 1, wherein the medical complication is a pregnancy.

3. The roadway medical complication alert method of claim 2, wherein the health care professional is a gynecologist.

4. The roadway medical complication alert method of claim 3, wherein the roadway medical complication alert device magnetically attaches to the vehicle.

5. The roadway medical complication alert method of claim 4, wherein the roadway medical complication alert device actuates when engaged to the vehicle.

6. The roadway medical complication alert method of claim 5, wherein the roadway authority is a Department of Motor Vehicles.

7. The roadway medical complication alert method of claim 6, wherein the roadway authority is a law enforcement officer.

8. A roadway medical complication alert device for a vehicle of a patient with at least one medical complication proceeding to a health care professional, the roadway medical complication alert device comprises of:
a base, wherein the roadway medical complication alert device actuates when the base engages the vehicle;
at least one lens member;
at least one illuminating member;
a power source;
a control circuit operatively connected to the at least one illuminating member to produce at least one visually distinct alerting light signal;
a beacon device for transmitting a vehicle position;
a remote processor for receiving transmissions of the vehicle position from the beacon device; and
a remote user interface for monitoring the vehicle position, wherein the remote user interface communicates with the remote processor.

9. The roadway medical complication alert device of claim 8, wherein each lens member is dome-shaped.

10. The roadway medical complication alert device of claim 9, wherein the illuminating member emits a pink light.

11. The roadway medical complication alert device of claim 10, wherein the power source is a lithium battery.

12. The roadway medical complication alert device of claim 11, wherein the base is magnetic and actuates the illuminating member upon engaging the vehicle.

13. The roadway medical complication alert device of claim 12, further comprises of a SIM card that alerts the remote processor that the roadway medical complication alert device is actuated.

14. The roadway medical complication alert device of claim 12, wherein each visually distinct alerting light signal also emits an audio alert.
